(19) United States
(12) Patent Application Publication
(10) Pub. No.: US 2024/0112515 A1
(43) Pub. Date: Apr. 4, 2024

(54) INTELLIGENT BOOT MANAGER OF VEHICLE SYSTEMS

(71) Applicant: Micron Technology, Inc., Boise, ID (US)

(72) Inventor: Qi Dong, Shanghai (CN)

(21) Appl. No.: 17/936,601

(22) Filed: Sep. 29, 2022

(51) Int. Cl. G07C 9/28; G06F 9/4401; G06F 9/54

(52) U.S. Cl. CPC G07C 9/28; G06F 9/4406; G06F 9/545

(57) ABSTRACT

Exemplary methods, apparatuses, and systems include an intelligent boot manager for controlling initialization of components of vehicle computing systems. The intelligent boot manager receives an access request for a vehicle. The intelligent boot manager initializes a set of components of vehicle systems of the vehicle in response to the access request. The intelligent boot manager executes a first portion of code from a read-only memory (ROM) location, the first portion of code configuring a processor to initialize a random-access memory (RAM) location. The intelligent boot manager downloads a set of applications to the RAM location. The intelligent boot manager receives an engine start request for the vehicle, wherein the engine start request is distinct from the access request. The intelligent boot manager initiates an engine start sequence of the vehicle in response to the engine start request.

### TECHNICAL FIELD

The present disclosure generally relates to managing boot operations in memory subsystems, and more specifically, relates to intelligently performing boot operations of vehicle systems.

### BACKGROUND ART

A memory subsystem can include one or more memory devices that store data. The memory devices can be, for example, non-volatile memory devices and volatile memory devices. In general, a host system can utilize a memory subsystem to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory subsystem in accordance with some embodiments of the present disclosure.

FIG. 2 is a flow diagram of an example method of intelligently initializing vehicle systems with error detection in accordance with some embodiments of the present disclosure.

FIG. 3 is a flow diagram of an example method to intelligently manage the boot operations in accordance with some embodiments of the present disclosure.

FIG. 4 is a block diagram of an example computer system in which embodiments of the present disclosure may operate.

### DETAILED DESCRIPTION

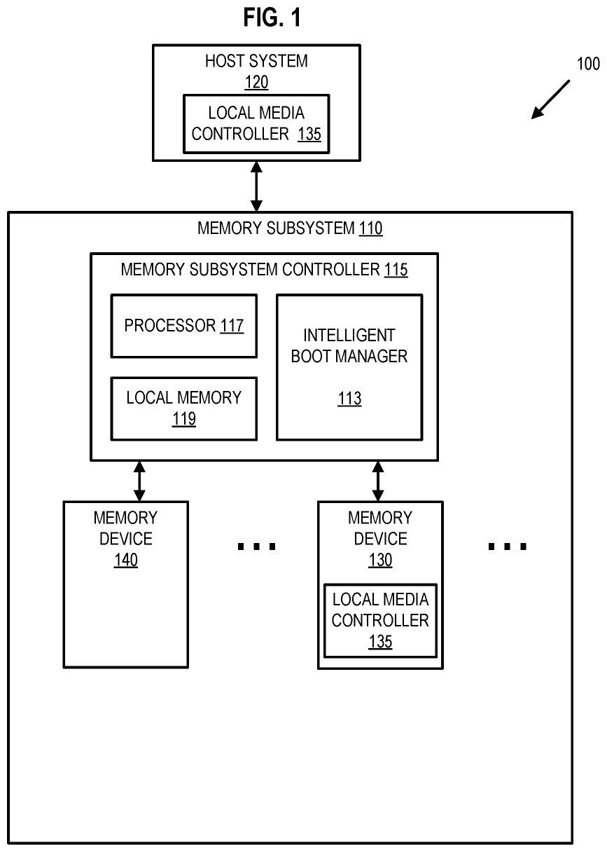

Aspects of the present disclosure are directed to managing initialization of components of vehicle systems. A memory subsystem can be a storage device, a memory module, or a hybrid of a storage device and memory module. Examples of storage devices and memory modules are described below in conjunction with FIG. 1. In general, a host system can utilize a memory subsystem that includes one or more components, such as memory devices that store data. The host system can provide data to be stored at the memory subsystem and can request data to be retrieved from the memory subsystem.

A memory device can be a non-volatile memory device. A non-volatile memory device is a package of one or more dice. One example of non-volatile memory devices is a negative-and (NAND) memory device. Other examples of non-volatile memory devices are described below in conjunction with FIG. 1. The dice in the packages can be assigned to one or more channels for communicating with a memory subsystem controller. Each die can consist of one or more planes. Planes can be grouped into logic units (LUN). For some types of non-volatile memory devices (e.g., NAND memory devices), each plane consists of a set of physical blocks, which are groups of memory cells to store data. A cell is an electronic circuit that stores information.

Depending on the cell type, a cell can store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple-level cells (TLCs), and quad-level cells (QLCs). For example, a SLC can store one bit of information and has two logic states.

Unlike some traditional enterprise applications for memory subsystems, such as solid-state drives (SSDs), operating environments for automotive technology systems have stringent requirements for initialization as the memory subsystems provide drivers access to and control of various components of the vehicle. For example, during runtime, the memory subsystem may be required to enable start and control of the vehicle components within a time threshold that is increasingly difficult as vehicle systems continue to become more complex. In typical systems, the vehicle engine is started and then the system information is read from non-volatile memory locations and written into random-access memory (RAM) locations for use by the vehicle systems to enable use of, e.g., a backup camera, proximity sensors, an entertainment system, etc. If any error (e.g., read/write) occurs, the process must be repeated, causing the initialization time to exceed the stringent time requirement and be considered non-compliant. As a result, the performance of the vehicle systems may be degraded or fail to meet initialization standard requirements.

Aspects of the present disclosure address the above and other deficiencies by utilizing a time interval after a user access request and before starting the engine of the vehicle to turn on necessary components, execute a first portion of code (e.g., a bootROM) to load a bootloader into RAM, and execute the bootloader to load components of the operating system (e.g., a kernel) and any applications required by the vehicle systems. An intelligent boot manager monitors the vehicle systems for the user access request and initiates the initialization prior to the engine start sequence. By using the time interval between the user access request and before starting the engine of the vehicle, the intelligent boot manager can provide immediate operation of key vehicle systems at engine start. Additionally, in the event of a failure during the process, an additional initialization process can be performed after the engine start while still satisfying the time threshold. This process improves reliability of the vehicle systems and reduces the complexity of optimizing memory access to fit various system boot conditions.

FIG. 1 illustrates an example computing system 100 that includes a memory subsystem 110 in accordance with some embodiments of the present disclosure. The memory subsystem 110 can include media, such as one or more volatile memory devices (e.g., memory device 140), one or more non-volatile memory devices (e.g., memory device 130), or a combination of such.

A memory subsystem 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory module (NVDIMM).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory subsystems 110. In some embodiments, the host system 120 is coupled to different types of memory subsystems 110. FIG. 1 illustrates one example of a host system 120 coupled to one memory subsystem 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., NVDIMM controller), and a storage protocol controller (e.g., PCIe controller, SATA controller). The host system 120 uses the memory subsystem 110, for example, to write data to the memory subsystem 110 and read data from the memory subsystem 110.

The host system 120 can be coupled to the memory subsystem 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory subsystem 110. The host system 120 can further utilize an NVM Express (NVMe) interface to access components (e.g., memory devices 130) when the memory subsystem 110 is coupled with the host system 120 by the PCIe interface. The physical host interface can provide an interface for passing control, address, data, and other signals between the memory subsystem 110 and the host system 120. FIG. 1 illustrates a memory subsystem 110 as an example. In general, the host system 120 can access multiple memory subsystems via a same communication connection, multiple separate communication connections, and/or a combination of communication connections.

The memory devices 130,140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as a three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Although non-volatile memory devices such as NAND type memory (e.g., 2D NAND, 3D NAND) and 3D cross-point array of non-volatile memory cells are described, the memory device 130 can be based on any other type of non-volatile memory, such as read-only memory (ROM), phase change memory (PCM), self-selecting memory, other chalcogenide based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

A memory subsystem controller 115 (or controller 115 for simplicity) can communicate with the memory devices 130 to perform operations such as reading data, writing data, or erasing data at the memory devices 130 and other such operations (e.g., in response to commands scheduled on a command bus by controller 115). The memory subsystem controller 115 can include hardware such as one or more integrated circuits and/or discrete components, a buffer memory, or a combination thereof. The hardware can include digital circuitry with dedicated (i.e., hard-coded) logic to perform the operations described herein. The memory subsystem controller 115 can be a microcontroller, special purpose logic circuitry (e.g., a field programmable gate array (FPGA), an application specific integrated circuit (ASIC), etc.), or another suitable processor.

The memory subsystem controller 115 can include a processing device 117 (processor) configured to execute instructions stored in a local memory 119. In the illustrated example, the local memory 119 of the memory subsystem controller 115 includes an embedded memory configured to store instructions for performing various processes, operations, logic flows, and routines that control operation of the memory subsystem 110, including handling communications between the memory subsystem 110 and the host system 120.

In some embodiments, the local memory 119 can include memory registers storing memory pointers, fetched data, etc. The local memory 119 can also include read-only memory (ROM) for storing micro-code. While the example memory subsystem 110 in FIG. 1 has been illustrated as including the memory subsystem controller 115, in another embodiment of the present disclosure, a memory subsystem 110 does not include a memory subsystem controller 115, and can instead rely upon external control (e.g., provided by an external host, or by a processor or controller separate from the memory subsystem 110).

In general, the memory subsystem controller 115 can receive commands or operations from the host system 120 and can convert the commands or operations into instructions or appropriate commands to achieve the desired access to the memory devices 130 and/or the memory device 140. The memory subsystem controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address) that are associated with the memory devices 130.

The memory subsystem controller 115 can further include host interface circuitry to communicate with the host system 120 via the physical host interface. The host interface circuitry can convert the commands received from the host system into command instructions to access the memory devices 130 and/or the memory device 140 as well as convert responses associated with the memory devices 130 and/or the memory device 140 into information for the host system 120.

The memory subsystem 110 can also include additional circuitry or components that are not illustrated. In some embodiments, the memory subsystem 110 can include a cache or buffer (e.g., DRAM) and address circuitry (e.g., a row decoder and a column decoder) that can receive an address from the memory subsystem controller 115 and decode the address to access the memory devices 130.

In some embodiments, the memory devices 130 include local media controllers 135 that operate in conjunction with memory subsystem controller 115 to execute operations on one or more memory cells of the memory devices 130. An external controller (e.g., memory subsystem controller 115) can externally manage the memory device 130 (e.g., perform media management operations on the memory device 130). In some embodiments, a memory device 130 is a managed memory device, which is a raw memory device combined with a local controller (e.g., local controller 135) for media management within the same memory device package. An example of a managed memory device is a managed NAND (MNAND) device.

The memory subsystem 110 includes an intelligent boot manager 113 that can monitor the vehicle for an access request and initialize components of the vehicle systems. In some embodiments, the controller 115 includes at least a portion of the intelligent boot manager 113. For example, the controller 115 can include a processor 117 (processing device) configured to execute instructions stored in local memory 119 for performing the operations described herein. In some embodiments, an intelligent boot manager 113 is part of the host system 120, an application, or an operating system.

The intelligent boot manager 113 can initialize components of the vehicle in response to receiving or otherwise detecting an access request to a vehicle and before initiating an engine start sequence. The engine can be a combustion engine, an electric motor, or other type of power conversion system that propels the vehicle using a fuel source. In an example, an engine start sequence can include turning a key, activating a button or lever, or a using an authorized client device to remotely initiate engine or motor operation. Examples of access requests include use of a mechanical key to unlock a vehicle door, an attempt to manipulate a door handle, a wireless signal requesting access the vehicle, etc. After an access request is received by the intelligent boot manager 113, a first portion of code is executed from a read-only memory (ROM) location. The first portion of code can be a bootROM that configures a random-access memory (RAM) to execute memory access commands requested by applications of various vehicle systems. The intelligent boot manager 113 can download a set of applications to the RAM location before the engine start sequence is initiated. By executing the bootROM and downloading the set of applications prior to the engine start sequence, the applications/components of the vehicle can be made available to the driver without substantial delay after initiating the engine start sequence. Further details with regards to the operations of the intelligent boot manager 113 are described below.

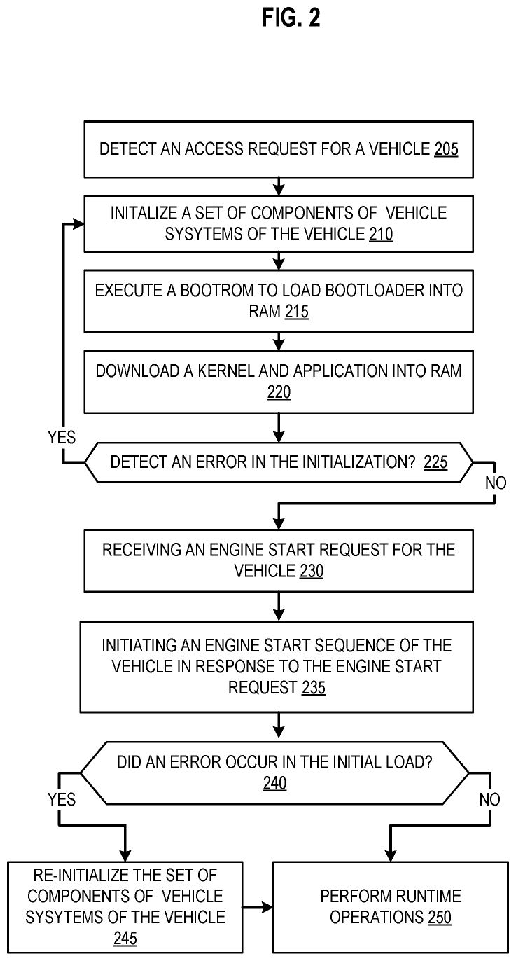

FIG. 2 is a flow diagram of an example method of intelligently initializing vehicle systems with error detection in accordance with some embodiments of the present disclosure. The method 200 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 200 is performed by the intelligent boot manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 205, the intelligent boot manager 113 detects an access request for a vehicle. In some embodiments, the intelligent boot manager 113 detects the use of a mechanical key to unlock a door, an attempt to manipulate a door handle, or a wireless request to access the vehicle (e.g., an electronic key, a remote client device application, etc.) from an authorized driver (e.g., an authenticated user). For example, the intelligent boot manager 113 is communicatively coupled to a transceiver of the vehicle that receives a communication from the electronic key or client device. In another example, the intelligent boot manager 113 is connected to a circuit that is coupled to a mechanical lock system of the vehicle that detects use of the mechanical lock system. In some embodiments, the intelligent boot manager 113 can receive the access request from another vehicle system, such as a security system that authenticates the access request, or otherwise detect that another system received an access request.

At operation 210, the intelligent boot manager 113 initializes a set of one or more components of vehicle systems of the vehicle in response to the access request. In some embodiments, the intelligent boot manager 113 activates one or more circuits of the vehicle in response to detecting the access request for the vehicle. For example, power circuitry for the memory device 130, low-power RAM, system-on-chip subsystems, and/or other power circuitry can be powered on.

At operation 215, the intelligent boot manager 113 executes a bootROM to load a bootloader into RAM. In some embodiments, the intelligent boot manager 113 executes a first portion of code stored in ROM, such as in local memory 119. An example of bootROM is a portion of code that is located in a fixed location in memory, such as embedded in the processor 117, and available to the processor 117 immediately after power-on voltage is provided to the processor 117. The bootROM initializes the hardware necessary to perform a boot operation (e.g., hardware busses, peripheral devices, etc.). After the hardware has been initialized, the bootROM loads the bootloader into RAM. In some embodiments, the bootloader is an application stored in non-volatile memory that controls the loading of a kernel or other applications into RAM.

At operation 220, the intelligent boot manager 113 downloads a kernel and one or more applications into RAM. In some embodiments, the intelligent boot manager 113 executes the bootloader to download the kernel for the operating system that controls the functions of the memory subsystem 110 and executes applications for the host system 120. The kernel controls hardware resources using device drivers and further is configured to control utilization of various resources of the processor 117 such as cache usage, processor allocation, and translating software requests to instructions for the processor 117. After the kernel is downloaded, various applications can be downloaded into RAM for performing any number of software functions of the memory subsystem 110 or to provide services to the host system 120.

At operation 225, the intelligent boot manager 113 detects if there was an error in the initialization performed at operations 210, 215, and 220. In some embodiments, during the initialization, a configuration error may occur. Examples of errors are a read error when downloading the kernel or the applications into RAM. Some errors may limit services or applications that the memory subsystem 110 is enabled to provide to the host system 120. If an error is detected during the initialization and before an engine start request is received, the method 200 returns to block 210. The operations 210, 220, and 225 can repeat iteratively until no error is detected or an engine start request is received. If no errors are detected, the method 200 proceeds to operation 230. In some embodiments, if an engine start request is received during operations 210, 215, 220, or 225, the method 200 proceeds to operation 230 and continues to perform operations 210, 215 220 during the engine start sequence. In other embodiments, if an engine start request is received during operations 210, 215, 220, or 225, the method 200 interrupts a current operation and the method 200 proceeds to operation 230 and stores an error state in memory.

At operation 230, the intelligent boot manager 113 receives an engine start request for the vehicle. In some embodiments, the intelligent boot manager receives an indication of a key start activation, a push button activation, a request from a client device, or other action to start the engine.

At operation 235, the intelligent boot manager 113 initiates an engine start sequence of the vehicle in response to the engine start request. In some embodiments, the engine start sequence includes ignition of a combustion engine, applying power to an electric motor, or another initiation for the engine of the vehicle.

At operation 240, the intelligent boot manager 113 checks the stored error state to determine if an error occurred during the initial load (e.g., an error detected at operation 225 that has not yet been resolved via reinitialization). In some embodiments, the intelligent boot manager 113 determines that an error occurred and receives an engine start request before an additional iteration of operations 210, 215, and 220. If an error was detected (e.g., setting an error code, a flag value, etc.) and has not been resolved by the engine start request at operation 230, the method 200 proceeds to operation 245.

At operation 245, the intelligent boot manager 113 re-initializes the set of components of vehicle systems of the vehicle. In some embodiments, the re-initialization involves performing an additional initialization similar to operations 215 and 220. By detecting the error at operation 225 prior to the engine start request and performing the re-initialization, errors that are identified can be corrected and the stringent time requirements can be satisfied.

At operation 250, the intelligent boot manager 113 performs runtime operations. In some embodiments, the intelligent boot manager 113 notifies the driver or the host system 120 that the initialization process is completed successfully. The runtime operations include running multiple applications for different components of the vehicle (e.g., multiple applications of a host system 120). Examples of applications include driver assistance applications, vehicle sensor systems and other applications.

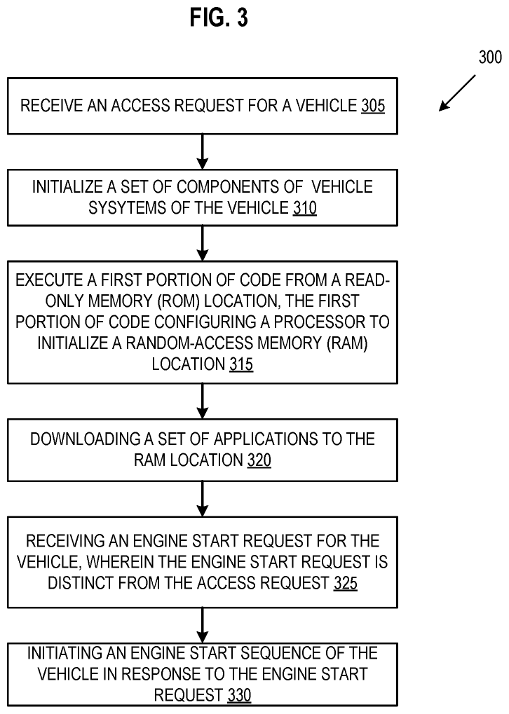

FIG. 3 is a flow diagram of an example method to intelligently manage the boot operations in accordance with some embodiments of the present disclosure. The method 300 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 300 is performed by the intelligent boot manager 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 305, the intelligent boot manager 113 receives an access request for a vehicle. As described above at operation 205, the intelligent boot manager 113 is communicatively coupled to a transceiver of the vehicle that receives a communication from the electronic key or client device or otherwise detects user access to the vehicle.

At operation 310, the intelligent boot manager 113 initializes a set of components of vehicle systems of the vehicle in response to the access request. As described above at operation 210, the intelligent boot manager 113 activates one or more circuits of the vehicle in response to detecting the access request for the vehicle.

At operation 315, the intelligent boot manager 113 executes a first portion of code from a read-only memory (ROM) location, the first portion of code configuring a processor to initialize a random-access memory (RAM) location. As described above at operation 215, the intelligent boot manager 113 executes the bootROM to load the bootloader.

At operation 320, the intelligent boot manager 113 downloads a set of applications to the RAM location. As described above at operation 220 downloads the kernel and the application that controls the functions of the operating system.

At operation 325, the intelligent boot manager 113 receiving an engine start request for the vehicle, wherein the engine start request is distinct from the access request. As described above at operation 235, the intelligent boot manager is communicatively coupled to the vehicle engine systems to determine that a request to start the vehicle engine has been received.

At operation 330, the intelligent boot manager 113 initiating an engine start sequence of the vehicle in response to the engine start request. As described above at operation 235, the engine start sequence includes initializing the engine or motor of the vehicle and includes requests to start combustion, electric, hybrid, or other types of engines.

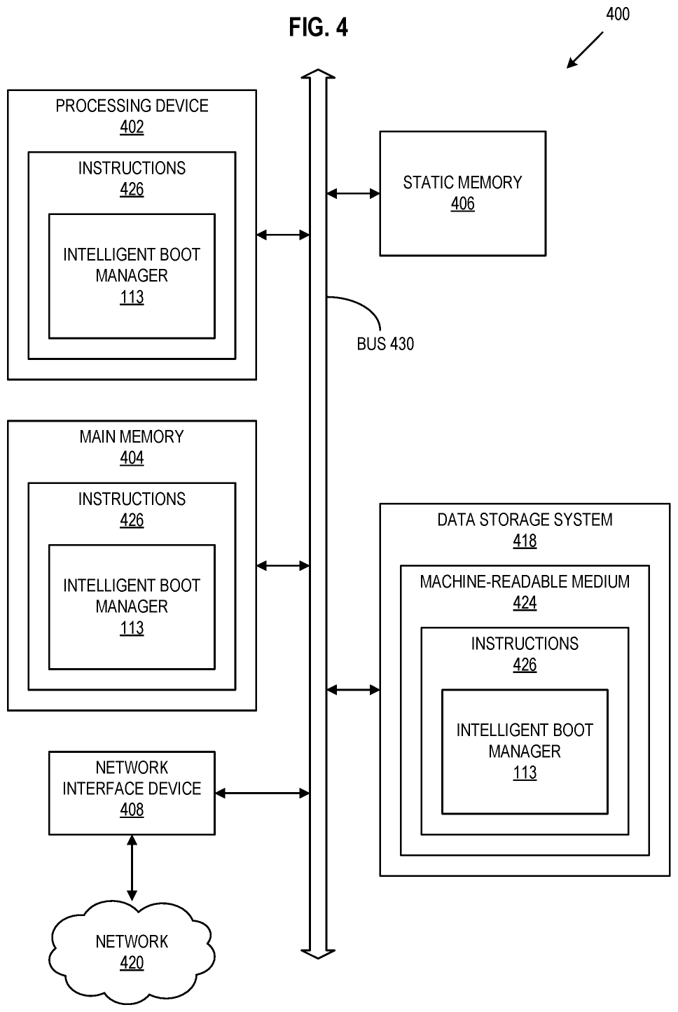

FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory subsystem (e.g., the memory subsystem 110 of FIG. 1) or can be used to perform the operations of a controller (e.g., to execute an operating system to perform operations corresponding to the intelligent boot manager 113 of FIG. 1). In alternative embodiments, the machine can be connected (e.g., networked) to other machines in a LAN, an intranet, an extranet, and/or the Internet. The machine can operate in the capacity of a server or a client machine in a client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

Processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory subsystem 110 of FIG. 1.

In one embodiment, the instructions 426 include instructions to implement functionality corresponding to an intelligent boot manager (e.g., the intelligent boot manager 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general-purpose computer selectively activated or reconfigured by a computer program stored in the computer. For example, a computer system or other data processing system, such as the controller 115, may carry out the computer-implemented methods 200 and 300 in response to its processor executing a computer program (e.g., a sequence of instructions) contained in a memory or other non-transitory machine-readable storage medium. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general-purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method comprising:
receiving an access request for a vehicle;
initializing a set of components of vehicle systems of the vehicle in response to receiving the access request;
executing a first portion of code from a read-only memory (ROM) location, the first portion of code configuring a processor to initialize a random-access memory (RAM) location;
downloading a set of applications to the RAM location;
receiving an engine start request for the vehicle, wherein the engine start request is distinct from the access request; and
initiating an engine start sequence of the vehicle in response to the engine start request.

2. The method of claim 1, wherein the set of applications includes a kernel and one or more applications to control the vehicle systems.

3. The method of claim 1 wherein the access request comprises an attempt to open a door using a mechanical key, a detection of an authorized driver, or a request to access the vehicle from an authorized client device.

4. The method of claim 1 further comprising:
in response to initiating an engine start sequence, executing the set of applications from the RAM location.

5. The method of claim 1 further comprising:
detecting an error during the initialization; and
performing an additional initialization after the engine start sequence.

6. The method of claim 1, wherein the first portion of code is a bootROM embedded in the processor.

7. The method of claim 1, wherein the set of components of the vehicle systems include a power circuit, system-on-chip, low-power RAM, and ROM.

8. A non-transitory computer-readable storage medium comprising instructions that, when executed by a processing device, cause the processing device to:
receive an access request for a vehicle;
initialize a set of components of vehicle systems of the vehicle;
execute a first portion of code from a read-only memory (ROM) location, the first portion of code configuring a processor to initialize a random-access memory (RAM) location;
download a set of applications to the RAM location;
receiving an engine start request for the vehicle, wherein the engine start request is distinct from the access request; and
initiate an engine start sequence of the vehicle in response to the engine start request.

9. The non-transitory computer-readable storage medium of claim 8, wherein the set of applications includes a kernel and one or more applications to control the vehicle systems.

10. The non-transitory computer-readable storage medium of claim 8, wherein the access request comprises an attempt to open a door using a mechanical key, a detection of an authorized driver, or a request to access the vehicle from an authorized client device.

11. The non-transitory computer-readable storage medium of claim 8, wherein the processing device is further caused to:
in response to initiating an engine start sequence, executing the set of applications from the RAM location.

12. The non-transitory computer-readable storage medium of claim 8, wherein the processing device is further caused to:
detecting an error during the initialization; and
performing an additional initialization after the engine start sequence.

13. The non-transitory computer-readable storage medium of claim 8, wherein the first portion of code is a bootROM embedded in the processing device.

14. The non-transitory computer-readable storage medium of claim 8, wherein the set of components of the vehicle systems include a power circuit, system-on-chip, low-power RAM, and ROM.

15. A system comprising:
a plurality of memory devices; and
a processing device, operatively coupled with the plurality of memory devices, to:
receive an access request for a vehicle;
initialize a set of components of vehicle systems of the vehicle;
execute a first portion of code from a read-only memory (ROM) location, the first portion of code configuring a processor to initialize a random-access memory (RAM) location;
download a set of applications to the RAM location;
receive an engine start request for the vehicle, wherein the engine start request is distinct from the access request; and
initiate an engine start sequence of the vehicle in response to the engine start request; and
detect an error during the initialization; and
perform an additional initialization after the engine start sequence.

16. The system of claim 15, wherein the set of applications includes a kernel and one or more applications to control the vehicle systems.

17. The system of claim 15, wherein the access request comprises an attempt to open a door using a mechanical key, a detection of an authorized driver, or a request to access the vehicle from an authorized client device.

18. The system of claim 15, wherein the processing device is further caused to:
in response to initiating an engine start sequence, executing the set of applications from the RAM location.

19. The system of claim 15, wherein the first portion of code is a bootROM embedded in the processing device.

20. The system of claim 15, wherein the set of components of the vehicle systems include a power circuit, system-on-chip, low-power RAM, and ROM.
